(19) United States
(12) Patent Application Publication
(10) Pub. No.: US 2013/0208349 A1
(43) Pub. Date: Aug. 15, 2013

(54) Laser feedback damage mitigation assembly and apparatus

(71) Applicant: David Balsley, Portland, OR (US)

(72) Inventor: David Balsley, Portland, OR (US)

(21) Appl. No.: 13/371,098

(22) Filed: Feb. 10, 2012

(51) Int. Cl. G02F 1/39; G02B 27/14

(52) U.S. Cl. 359/330; 359/634

(57) ABSTRACT

A laser assembly includes a semiconductor diode laser having an exit facet and capable of emitting a beam at a selected wavelength from the exit facet, a fast axis collimator optically coupled to the exit facet, the fast axis collimator for receiving the beam emittable from the exit facet and for collimating the beam along the fast axis thereof, and the fast axis collimator has one or more exterior surfaces, such that at least one of the one or more exterior surfaces includes a coating that is highly reflective for reflecting light at wavelengths other than the selected wavelength and anti-reflective for transmitting light at the selected wavelength.

### BACKGROUND OF THE INVENTION

1. Field of the Invention

Generally, the field of the present invention is diode lasers. More particularly, the present invention relates to the feedback damage mitigation in laser assemblies.

2. Background

Diode lasers are often used to pump other laser media because of their numerous advantages, including low cost and compatibility with electronic equipment. Moreover, diode lasers typically can be highly efficient and operate at a high power. In a typical end-pumping type application one or more diode lasers in the form of single-emitters or laser bars are optically coupled to a solid state block. The diode laser pump excites the laser gain material of the solid state block at a selected wavelength. The laser gain material then lases and emits a beam at a different longer wavelength. The pump beam passes through one of the mirrors of the resonator, typically highly-reflective at the lasing wavelength. The mirror coating is frequently applied to the surface of the solid state block optically coupled to the diode laser pump or applied to another optical component, such as a mirror reflector. The resonator mirror tends to protect the diode from light at the lasing wavelength, however, a separate dichroic filter is typically disposed between the diode pump and solid state block to further prevent the longer wavelength light from entering the diode laser pump. The additional dichroic adds complexity to the laser assembly and introduces additional alignment and reliability problems. Accordingly, there remains a need for a laser assembly that remains highly reliable without the need for a dichroic filter.

### SUMMARY OF THE INVENTION

Thus, the present invention satisfies the aforementioned need by introducing an innovation directed to the problem of the additional dichroic filter. Generally speaking, according to one aspect of the present invention a fast axis collimation optic optically coupled to a diode laser pump is coated with one or more materials so that the fast axis collimation optic exhibits anti-reflective properties at the wavelength of the pump and high-reflective properties at least one wavelength or wavelength range not emitted by the pump.

According to another aspect of the present invention, a laser assembly includes a semiconductor diode laser having an exit facet, the semiconductor diode laser being capable of lasing at a selected wavelength and emitting a diode laser beam at the selected wavelength from the exit facet, a fast axis collimator having one or more exterior surfaces, the fast axis collimator being optically coupled to the exit facet of the semiconductor diode laser, wherein at least one of the one or more exterior surfaces is coated so as to be highly reflective of light at one or more wavelengths different from the selected wavelength.

In still another aspect of the present invention, a laser apparatus includes one or more diode lasers, each including an exit facet and each configured to emit a pump beam at a pump wavelength from each respective exit facet, a fast axis collimator optically coupled to the exit facet, the fast axis collimator for receiving the pump beam emittable from the exit facet and for collimating the pump beam along the fast axis thereof, the fast axis collimator having one or more exterior surfaces, and a solid state block including first and second surfaces, the first surface optically coupled to the fast axis collimator for receiving the collimated pump beam, the solid state block capable of emitting a block beam from the second surface at a block wavelength, wherein at least one of the one or more exterior surfaces of the fast axis collimator includes a coating that is highly reflective for reflecting light at least at the block wavelength and anti-reflective for transmitting light at the pump wavelength.

The foregoing and other objects, features, and advantages will become more apparent from the following detailed description, which proceeds with reference to the accompanying figures.

### BRIEF DESCRIPTION OF THE DRAWINGS

FIG. 1 is a perspective view of a laser assembly according to an aspect of the present invention.

FIG. 2 is a top view of the laser assembly in FIG. 1.

FIG. 2A is a close-up view of a portion of FIG. 2.

### DETAILED DESCRIPTION OF THE INVENTION

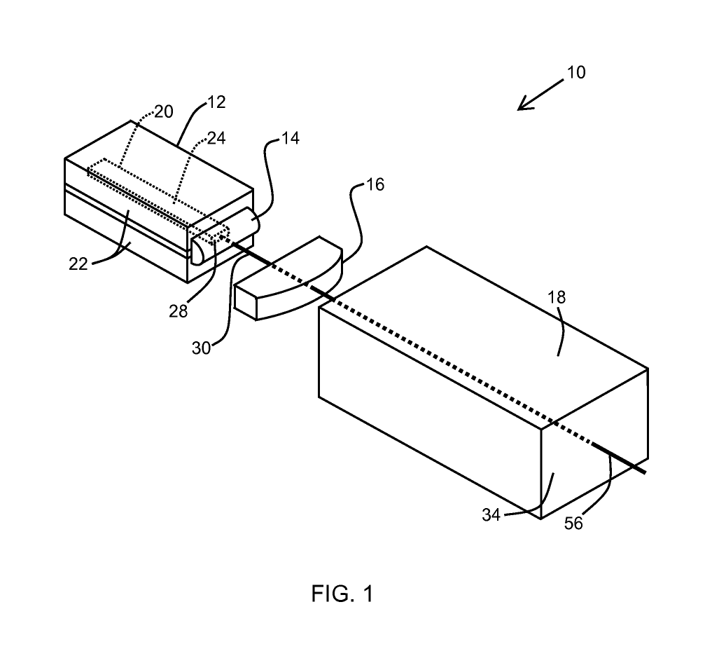

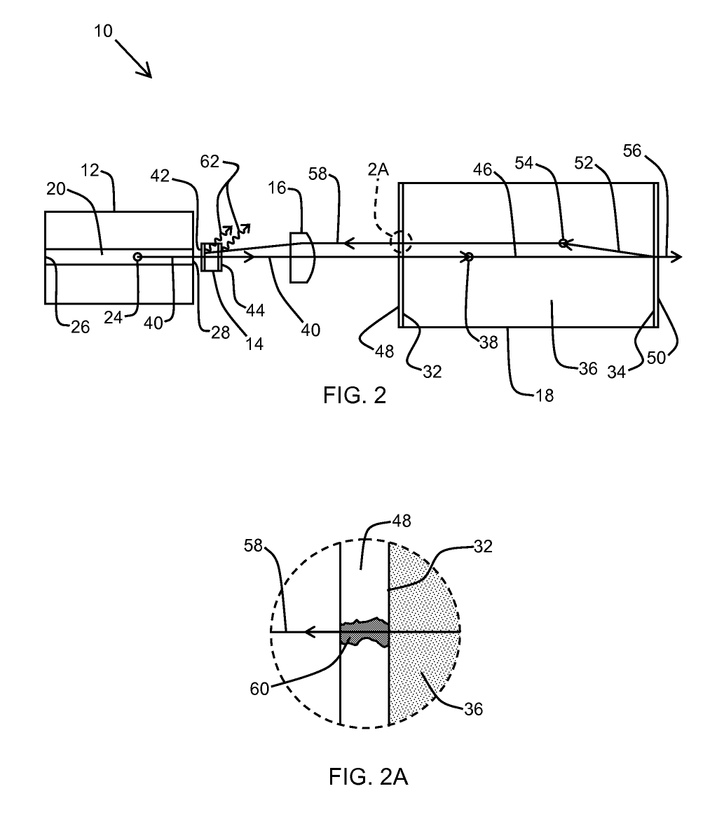

Referring to FIGS. 1 and 2, a laser assembly 10 is shown according to one embodiment of the present invention. The laser assembly 10 includes a semiconductor diode laser 12 optically coupled to a fast axis collimator 14, a slow axis collimator 16, and a solid state block 18. (Alternatively, the laser assembly 10 may be referred to or characterized as a laser apparatus.) The diode laser 12 includes a resonator region 20 disposed between layers of semiconductor material 22 and that has laser gain material 24 within the region 20 allowing laser operation when the diode laser 12 becomes biased. In various embodiments of the present invention, different types of diode lasers may be used according to the purposes to which the laser assembly will be used. Moreover, in some embodiments slow axis collimator 16 may be absent or other optical components may be used instead, such as one or more spherical optics. In some examples, optical coupling between various optical components, including between diode laser 12, fast axis collimator 14, and solid state block 18 may include additional optical components, such as lenses, mirrors, waveguides, filters, etc.

The resonator region 20 of the diode laser 12 is typically confined by two opposite facet surfaces forming a first facet 26 at one end and a second facet 28 at the other. During operation a diode laser beam 30 is emitted from the second facet 28 or exit facet. In some embodiments a high-reflective coating is applied to the first facet 26 in order to make laser operation more efficient. The exit facet 28 typically has a coating applied thereto so that laser operation in the resonator region 20 is optimized for the diode laser 12, though laser operation with an uncoated exit facet 28 is also possible. Diode laser beams are generally characterized by a fast and slow orthogonal axes perpendicular to the direction of beam propagation and corresponding to fast and slow beam divergences respectively. To collimate the more quickly diverging fast axis, fast axis collimator 14 is optically coupled in close relation to exit facet 28 so that the fast axis collimator 14 may receive the divergent beam 30 and collimate the fast axis thereof.

Fast axis collimators 14 may be of various configurations, including cylindrical, a-cylindrical, D-shaped, gradient-index, toroidal, mirror, or other geometries, and may be attached to the diode laser 12 or spaced apart but in sufficiently close relation to capture the divergent beam 30. Fast axis collimators 14 can be made of glass, GaP, Si, or other materials or combinations of materials. In some embodiments, fast axis collimator 14 is a microlens array. In one example of such an array, a plurality of lenses are formed in one piece of glass or other material so that multiple lenses form the array. To optically interact with diode laser beam 30, fast axis collimators 14 are transparent at the wavelength or wavelength range of the diode laser beam 30 emitted through exit facet 28. The fast axis collimators are typically coated with a material to provide anti-reflection properties to the surface so as to prevent light from reflecting and returning to the diode resonator 20, which may cause damage to the diode 12 or laser assembly 10.

Slow axis collimator 16 is spaced apart from fast axis collimator 14 and optically configured to receive diode laser beam 30 and to collimate the beam 30 along the slow axis thereof as the beam 30 propagates through the collimator 16. During typical operation, beam 30 is a pump beam characterized by a pump wavelength or wavelength range and is substantially collimated across both fast and slow axes or is otherwise configured to have an optimal divergence for subsequent optical coupling to solid state block 18 for pumping the gain medium therein. Solid state block 18 is generally provided in a suitable geometry for various laser design requirements, such as pulse length, frequency conversion, peak power, etc. A rectangular block geometry is suitable for many applications, though other geometries are possible. By way of example, a cylindrical tube or a folded cavity may be used. Solid state block 18 typically includes a pump input surface 32, a block output surface 34, and an interior resonator region 36. The diode laser beam 30 propagates through the input surface 32 and through solid state block 18. In an overview of typical operation, by propagating through the resonator region 36 of block 18, diode laser beam 30 excites active ions 38 therein. Pumped ions 38 can relax to a lower state and emit a light of a particular wavelength or range of wavelengths. Light of the particular wavelength characteristic of the solid state block 18 can then resonate within the block 18 and emit it at the output surface 34. While typically the input and output surfaces 34, 36 are opposite one another, in some embodiments they are not, such as in some side-pumping or folded cavity arrangements.

Referring now to FIG. 2, a top view of laser system 10 illustrates the damage protective techniques according to one embodiment of the present invention. Laser gain material 24 of the diode laser 12 emits a laser diode beam having an example ray 40 propagating through and past the exit facet 28. Slow axis collimator 14 includes a coated exterior input surface 42 and coated exterior output surface 44 and is situated adjacent to the exit facet 28 and optically coupled therewith so as to receive example ray 40 through the input surface 42 and to transmit the ray 40 through output surface 44. Thus, collimator 14 and coated surfaces 42, 44 thereof are substantially transparent at the wavelength of example ray 40. To achieve the substantial transparency at the surfaces 42, 44 the coating of the coated surfaces 42, 44 has anti-reflective properties at the wavelength of the example ray 40. For example, diode lasers typically emitting at wavelengths around 800 nm or around 940 nm will thus be coupled with a slow axis collimation optics having surfaces 42, 44 coated with one or more coatings such that at least one of the coatings exhibits anti-reflective properties at the corresponding wavelengths of around 800 nm or 940 nm.

Example ray 40 at a pump wavelength propagates through and past a slow axis collimation optic 16 and enters solid state block 18 through input surface 32 before exciting an active ion 38 of the resonator region 36 of the block 18. A lower frequency example ray 46 at a (longer) block wavelength is emitted from the active ion 38 and propagates towards the output surface 34. To optimize laser operation within block 18, input and output surfaces 32, 34 are typically coated with separate coatings 48, 50, respectively, exhibiting selected high-reflective properties at the longer wavelength characterized by the solid state block 18, such as 1064 nm or 1030 nm, by way of example. In some embodiments the coating 48 is applied to a separate optic disposed in relation to the block 18, such as a separate mirror, such that the separate optic defines input surface 32. However, to allow penetration of light at the pump wavelengths provided by diode laser 12 at least the input coating should have anti-reflective properties as well. In a representative fashion, in many instances an example reflected ray 52 is reflected back towards the interior of the solid state block 18 and may interact with other active ions such as other active ion 54 while other rays may not get reflected and continue to propagate past the output surface 34 in the form of an output beam 56 of the solid state block 18.

By way of example operation, through the process of stimulated emission the interaction of reflected ray 52 with other active ion 54 may cause another example ray 58 to be emitted at the longer wavelength of the solid state block 18. In some circumstances, example ray 58 may propagate through and past the input surface 32 even though high-reflective coating 48 is applied to the surface 32. As shown in close-up in FIG. 2A, example ray 58 encounters a void 60 and does not become reflected back towards the interior of block 18. Normally, such a ray 58 may propagate through the collimation optics 14, 16 and into the diode laser interior region 20. In many situations laser light such as example ray 58 may cause catastrophic damage to the diode laser 12 and render the laser assembly 10 inoperable or partly damaged, particularly as the photon flux density increases during laser operation. Thus, when pumping a solid state block 18 the diode is vulnerable to leakage at the lasing wavelength of the solid state block 18 through the coating thereon or through associated reflective optics such as a reflective mirror disposed in relation to the block 18. Voids 60 may have various origins, including scratches, blemishes, or lot variation of the coating applied to the block 18. To counteract the voids and damage, a separate optic (not shown), such as a dichroic filter, is typically introduced in the optical path that may operate similarly to the coated block that will allow the wavelength of light emitted by the diode laser 12 to pass and to block the wavelength of light at the laser wavelength of the solid state block 18. However, the introduction of additional optical elements leads to separate reliability and manufacturing problems for laser assemblies.

Thus, to mitigate voids and optical failures while eliminating the need of a separate optic, fast axis collimation coated surfaces 42, 44 have anti-reflective properties at the wavelength of the diode laser 12 and high-reflective properties at the wavelength of the solid state block 18 so as to form a dichroic fast axis collimator. Herein, suitable high-reflective or highly reflective properties include reflectivities between 90 and 100 percent, as well as 80 percent or as low as 50 percent. Also herein, suitable anti-reflective properties include transparencies between 90 and 100 percent, as well as 80 percent or as low as 50 percent. Generally, the extent of high-reflective properties depends on the extent of anti-reflective properties, and so in various embodiments each may be optimized for different purposes or design constraints. Upon interaction with fast axis collimation optic, example ray 58 at the longer wavelength of the solid state block becomes reflected away 62 and fails to propagate into the diode laser 12. In some embodiments the high-reflective properties at the wavelength of the solid state block 18 only occur on one side of the optic 14, such as only coated output surface 44. In conventional coatings on fast axis collimators 14, the surfaces thereof are typically only anti-reflective coated to ensure transmission of the pump light form the diode laser 12. Herein, the coatings on the fast axis collimator 14 are modified to be high-reflective as well, effectively blocking light leaking back from the gain medium of the solid state block 18, other gain mediums, optical parametric oscillators, or other optical elements that may form a part of the laser assembly 10. For example, block 18 may include a passive or active q-switch optically coupled thereto. In some examples, the q-switch is separate from the block 18 while in other examples the q-switch is attached to the block 18 or formed within block 18.

It is thought that the present invention and many of the attendant advantages thereof will be understood from the foregoing description and it will be apparent that various changes may be made in the parts thereof without departing from the spirit and scope of the invention or sacrificing all of its material advantages, the forms hereinbefore described being merely exemplary embodiments thereof.

What is claimed is:

1. A laser assembly comprising:
at least one semiconductor diode laser having an exit facet and capable of emitting a beam at a selected wavelength from said exit facet;
a fast axis collimator optically coupled to said exit facet, said fast axis collimator for receiving the beam emittable from said exit facet and for collimating the beam along the fast axis thereof; and
said fast axis collimator having one or more exterior surfaces, at least one of said one or more exterior surfaces including a coating that is highly reflective for reflecting light at wavelengths other than the selected wavelength and anti-reflective for transmitting light at the selected wavelength.

2. The laser assembly of claim 1 further comprising a solid state block having first and second surfaces, said first surface optically coupled to said fast axis collimator for receiving the beam collimated thereby, said solid state block capable of emitting a beam from said second surface at a solid state block wavelength.

3. The laser assembly of claim 2 wherein said coating is highly reflective at the solid state block wavelength.

4. The laser assembly of claim 2 wherein said first surface of said solid state block includes a first surface coating that is highly reflective at the solid state block wavelength.

5. The laser assembly of claim 1 wherein said at least one semiconductor diode laser comprises a plurality of semiconductor diode lasers, wherein said plurality of semiconductor diode lasers is in a bar configuration.

6. The laser assembly of claim 1 wherein said at least one semiconductor diode laser comprises a plurality of semiconductor diode lasers, wherein each semiconductor diode laser of said plurality of semiconductor diode lasers is each a separate emitter not configured in a bar.

7. The laser assembly of claim 1 wherein said fast axis collimator is attached to said exit facet.

8. The laser assembly of claim 1 wherein said fast axis collimator is spaced apart from said exit facet.

9. The laser assembly of claim 1 further comprising a slow axis collimator optically coupled to the diode laser beam and interposed between said fast axis collimator and said solid state block and for collimating the diode laser beam along the slow axis thereof.

10. The laser assembly of claim 1 further comprising an optical parametric oscillator optically coupled to said solid state block.

11. A laser apparatus comprising:
one or more diode lasers, each including an exit facet and each configured to emit a pump beam at a pump wavelength from each respective exit facet;
a fast axis collimator optically coupled to said exit facet, said fast axis collimator for receiving the pump beam emittable from said exit facet and for collimating the pump beam along the fast axis thereof, said fast axis collimator having one or more exterior surfaces; and
a solid state block including first and second surfaces, said first surface optically coupled to said fast axis collimator for receiving the collimated pump beam, said solid state block capable of emitting a block beam from said second surface at a block wavelength;
wherein at least one of said one or more exterior surfaces of said fast axis collimator includes a coating that is highly reflective for reflecting light at least at the block wavelength and anti-reflective for transmitting light at the pump wavelength.

12. The laser apparatus of claim 11 wherein said first surface of said solid state block includes a first surface coating that is highly reflective at the block wavelength.

13. The laser apparatus of claim 11 wherein said fast axis collimator includes a plurality of fast axis collimation lenses optically coupled to said one or more diode lasers.

14. The laser apparatus of claim 11 wherein said fast axis collimator is a microlens array.

15. The laser apparatus of claim 11 wherein said one or more diode lasers comprises a plurality of diode lasers, wherein said plurality of diode lasers is in a bar configuration.

16. The laser apparatus of claim 11 wherein said at least one semiconductor diode laser comprises a plurality of semiconductor diode lasers, wherein each semiconductor diode laser of said plurality of semiconductor diode lasers is each a separate emitter not configured in a bar.

17. The laser apparatus of claim 11 wherein said fast axis collimator is attached to said exit facet.

18. The laser apparatus of claim 1 wherein said fast axis collimator is spaced apart from said exit facet.

19. The laser apparatus of claim 11 further comprising a slow axis collimator optically coupled to the diode laser beam and interposed between said fast axis collimator and said solid state block and for collimating the diode laser beam along the slow axis thereof.

20. The laser apparatus of claim 11 further comprising an optical parametric oscillator optically coupled to said solid state block.
